(19) United States
(12) Patent Application Publication
(10) Pub. No.: US 2009/0293254 A1
(43) Pub. Date: Dec. 3, 2009

(54) INTEGRATED WASH UNIT FOR A TURBINE ENGINE

(76) Inventors: Robert M. Rice, Huntsville, AL (US); William J. Welch, Madison, CT (US); David G. Diamos, Hartford, CT (US)

Correspondence Address: CARLSON, GASKEY & OLDS/PRATT & WHITNEY, 400 WEST MAPLE ROAD, SUITE 350, BIRMINGHAM, MI, 48009, US

(21) Appl. No.: 12/495,123

(22) Filed: Jun. 30, 2009

Related U.S. Application Data
(62) Division of application No. 11/843,073, filed on Aug. 22, 2007.

(51) Int. Cl. B23P 11/00

(52) U.S. Cl. 29/428

(57) ABSTRACT

An integrated wash unit includes a framework. In one example, the framework includes a skid supporting an internal frame. A wash unit that includes a pump is supported on the framework for pumping a fluid, such as water. A water treatment assembly is supported on the framework and is fluidly connected to the pump. A water storage tank and water heater are arranged between the water treatment assembly and pump. The water treatment assembly supplies clean water that was been recycled from the collected, unclean water from the turbine engine. The water treatment assembly is fixed relative to the wash unit for transport together with the wash unit as an integrated assembly. An enclosure that includes access panels is supported on the framework about the wash unit and water treatment assembly. The framework supports a power plant that drives the pump through a generator and motor or through a transmission device, as well as a generator and an air compressor.

This application is a divisional application of U.S. application Ser. No. 11/843,073, which was filed on Aug. 22, 2007.

### BACKGROUND

This application relates to an integrated wash unit for use in washing aircraft turbine engines, for example. More particularly, the application relates to the packaging and manufacture of various wash unit and water treatment assembly components.

Aircraft turbine engines accumulate particulates and debris over time that adversely affect the turbine engine's efficiency. As a result, aircraft maintenance routines have included periodic disassembly of various turbine engine components for cleaning. More recently, the aircraft industry has begun to adopt a more automated cleaning of the turbine engine while the turbine engine is still mounted on the aircraft's airframe.

One example approach is to transport to the aircraft the components needed to wash the turbine engine and reclaim the contaminated water on-site for reuse or disposal. The contaminated water from the turbine engine cannot contaminate the surrounding environment, but must be collected in a controlled setting. One system sprays heated, atomized water through a water manifold into the forward end of the turbine engine's nacelle. Debris is removed from the turbine engine components and expelled from the aft end of the nacelle where the unclean water is collected by a water collector. This on-aircraft turbine engine cleaning procedure avoids or delays disassembly of the turbine engine for hand cleaning and improves the engine's efficiency.

Typically, all of the various components of the wash unit and water treatment assembly are brought separately to the aircraft site. For example, an engine driven pump may be brought to the site separately from a generator. Storage tanks and heaters for clean water may also be transported separately from the other wash unit components. Various water treatment assembly components, such as water reclamation tanks, water treatment containers, deionizing tanks and various hose reels and plumbing are typically separate from one another and transported to the site separately from the wash unit components.

One desired feature of on-aircraft cleaning of the turbine engine is the reduced downtime for maintenance. However, transporting and assembling the various wash unit and water treatment assembly components at the site increases the maintenance time. Further, transporting separate components using typical airport vehicles can be difficult.

What is needed is an improved manner of packaging and manufacturing a wash unit and water treatment assembly for use in cleaning turbine engines.

### SUMMARY

An integrated wash unit includes a framework. In one example, the framework includes a skid supporting an internal frame. A wash unit that includes a pump is supported on the framework for pumping water. A water treatment assembly is supported on the framework and is fluidly connected to the pump. A water storage tank and water heater are fluidly arranged between the water treatment assembly and pump, in one example. The water treatment assembly supplies clean water that was been recycled from the collected, unclean water from the turbine engine.

The water treatment assembly is fixed relative to the wash unit for transport together with the wash unit as an integrated assembly. An enclosure that includes access panels is supported on the framework about the wash unit and water treatment assembly. The water treatment assembly includes a water reclamation tank for storing unclean water retrieved from the turbine engine. The water treatment assembly also includes water treatment containers having chemicals and/or filters for removing undesired material from the unclean water to recycle the water for reuse. In one example, the water treatment assembly also includes deionizing tanks.

In one example, the framework supports a power plant that drives the pump through a transmission device. A generator and an air compressor are also driven by the power plant. In another example, the framework supports a power plant that drives a generator, which powers the pump through a motor that is directly coupled to the pump.

Accordingly, an integrated wash unit is provided for transport on a variety of vehicles by having the wash unit and water treatment assembly secured to a common framework in a compact arrangement with one another.

These and other features of the application can be best understood from the following specification and drawings, the following of which is a brief description.

### BRIEF DESCRIPTION OF THE DRAWINGS

FIG. 1a depicts an example integrated wash unit on a truck with a custom bed.

FIG. 1b illustrates the integrated wash unit on a truck with a standard bed.

FIG. 1c illustrates the integrated wash unit for transport on a trailer.

FIG. 1d illustrates the integrated wash unit transported on a aircraft luggage dolly.

FIG. 2a is a top elevational view of an example integrated wash unit.

FIG. 2b is a side elevational view of the integrated wash unit shown in FIG. 2a.

FIG. 2c is a rear elevational view of the integrated wash unit shown in FIG. 2a.

FIG. 3 is a schematic view illustrating water processing within the integrated wash unit during a turbine engine cleaning procedure.

FIG. 4 is a schematic view of a pump drive system.

FIG. 5 is a schematic view of a heater for a water storage tank.

### DETAILED DESCRIPTION OF THE PREFERRED EMBODIMENT

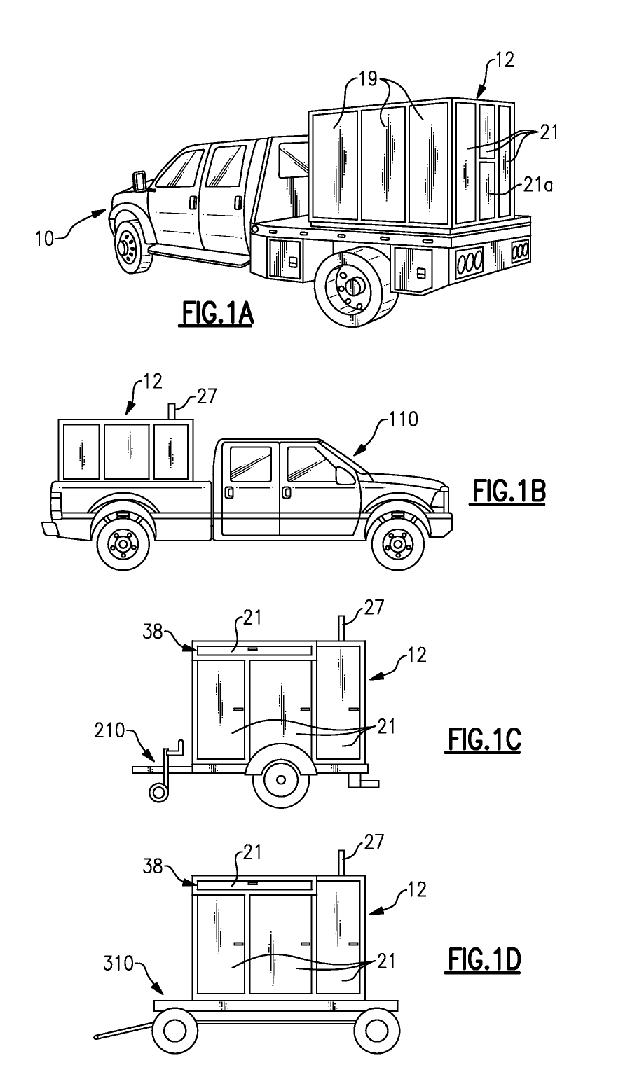

This application is directed to a portable integrated wash unit 12 housing wash unit and water treatment assembly components for transport on various types of vehicles 10, 110, 210, 310 shown in FIGS. 1a-d The vehicles 10, 110, 210, 310 are commonly used at airports. The example integrated wash unit is configured for transport in an aircraft cargo area as well so that it can easily be transported between airports.

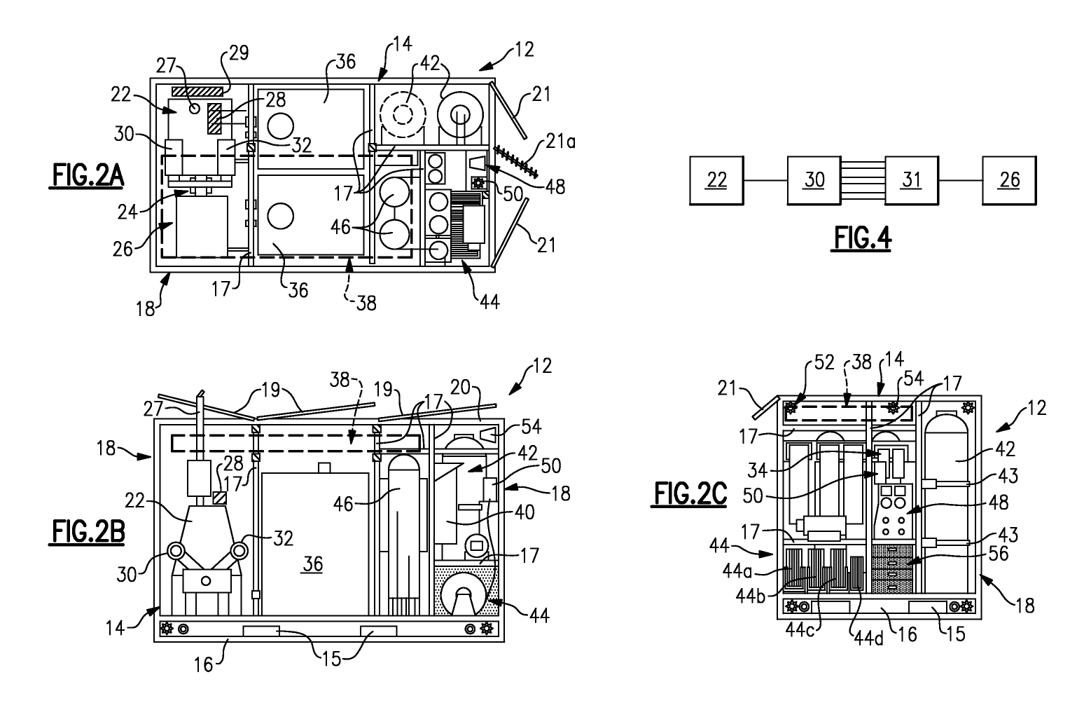

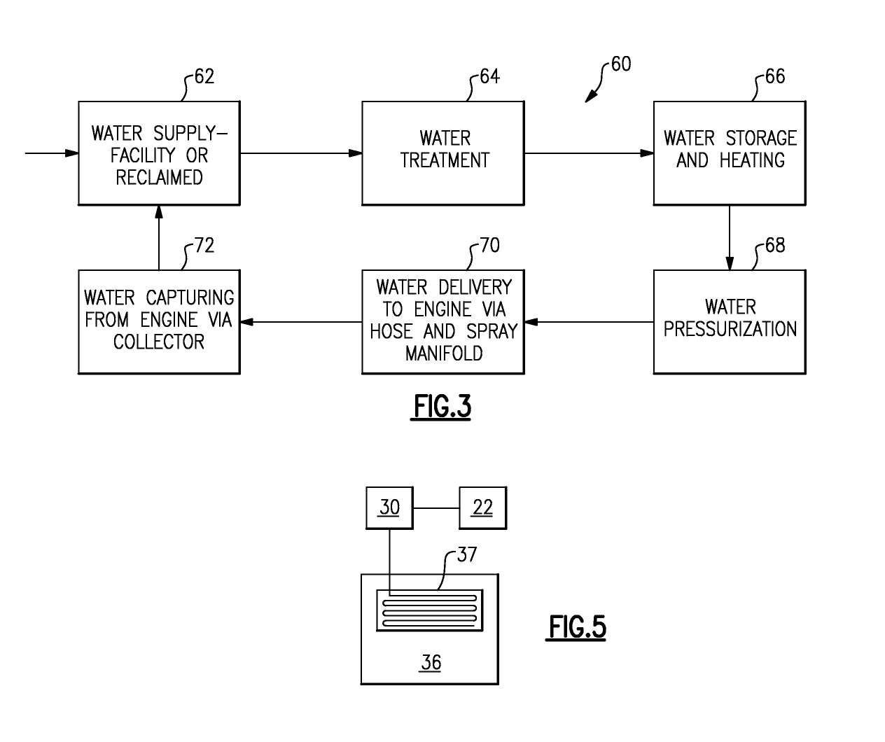

The integrated wash unit 12 combines multiple subsystems into a single integrated unit. The unit consists of components for jet engine water washing, water treatment, pneumatic generation and power generation-all mounted on a common framework 14 (shown in FIGS. 2a-2c). As illustrated in the Figures, the integrated wash unit 12 packages compactly many components that can be transported easily on any one of a truck (custom box shown in FIG. 1a, standard box shown in FIG. 1b), trailer (FIG. 1c) and aircraft luggage dolly (FIG. 1d), for example. The compact, integrated wash unit 12 simplifies logistics and operations; reduces shipping and storage constraints and costs, weight, volume and footprint; and improves safety and energy efficiency.

Referring to FIGS. 2a-2c, the integrated wash unit 12 and its framework 14 supports and secures multiple subsystems, such as the wash unit and water treatment assembly, and their components. The framework 14 includes a skid 16 having fork openings 15 for accommodating forks from a lift truck. The skid 16 may also include features for locking the integrated wash unit 12 to the transport vehicle. The skid 16 supports an internal frame 17 to which components can be secured. An enclosure 18 is supported by the internal frame 17 and external frame and/or walls 20. The enclosure 18 includes various access panels, such as removable panels 19, hinged panels 21 and clear panels 21a, which provide visibility to components behind the clear panel 21a. In one example, the enclosure 18 and any associated framework 14 substantially encloses the entire wash unit and water treatment assembly.

A power plant 22 is supported on the skid 16 and drives a pump 26 through a transmission device 24. The transmission device 24 is a transmission and/or clutch in one example. The power plant 22 can be a gasoline or diesel engine, for example, or an electric motor. In another example schematically shown in FIG. 4, a power plant 22 drives a generator 30 that powers the pump 26 through an electric motor 31 that is directly coupled to the pump 26.

The pump 26 provides clean water to the wash manifold (not shown) for cleaning the turbine engine. A water collector (not shown) is arranged beneath the turbine engine to collect the used, unclean water. In one example, another pump (not shown) is externally located from the integrated wash unit 12, for example, to pump the unclean water from the water collector back to the integrated wash unit 12 for recycling.

In the example in which the power plant 22 is an internal combustion engine, an exhaust 27 from the power plant 22 extends through the enclosure 18. An air-to-water heat exchanger 28 is in fluid communication with the exhaust 27 to use the heat generated by the power plant 22 to heat the water used in cleaning the turbine engine. Another heat exchanger 29, for example a water-to-water heat exchanger, can be used to provide supplemental heating to the water.

A generator 30 and an air compressor 32 are supported by the framework 14 and are driven by the power plant 22 to provide desired electricity and compressed air at the work site. An air filter, regulator and dryer 34 are arranged downstream from and in fluid communication with the air compressor 32 for supplying compressed air. In another example, the air compressor 32 is driven by an electric motor 31 that is powered by the generator 30, similar to the pump drive system shown in FIG. 4.

One or more water storage tanks 36 are supported on the framework 14 to store clean water for use in cleaning the turbine engine. The water within the storage tank 36 is first heated by the heat exchangers 28 and 29, in one example. In another example shown in FIG. 5, electrically powered heaters 37 within the tanks 36 also heat the water within the tanks 36. The water within the storage tank 36 is recycled water that has been collected from the turbine engine and treated and/or fresh water provided by the facility.

The wash unit is a subsystem that includes the components for supplying clean water to the turbine engine. In one example, the wash unit includes, the power plant 22, pump 26, storage tanks 36, heat exchangers 28, 29 and associated components.

The water treatment assembly includes water treatment containers 40 having chemicals and/or filters for removing undesired material, such as heavy metals and particulates. The water treatment containers 40 receive filtered water from water reclamation tanks 46, which receive and filter unclean water from the water collector. Deionizing tanks 42 deionize the treated water from the water treatment containers 40 and facility water prior to storage in storage tanks 36. The deionizing tanks 42 are secured to the internal frame 17 by clamps 43, for example.

Hose reels 44 are supported by the framework 14. The hose reels 44 include inlet reel 44a that receives the collected unclean water and supplies it to the water reclamation tank 46. Outlet reel 44b supplies water from the storage tank 36 to the water manifold for cleaning turbine engine. Reel 44c is connected to the facility water and supplies fresh water to the storage tank 36 to provide additional water as needed. Reel 44d provides compressed air from the air compressor 32 that flows through the air filter, regulator and dryer 34.

Controls 48 are supported by the framework 14 and are visible by the operator through the clear panel 21a. The controls 48 include various meters, sensors, computer processors and other indicators that enable operation of the integrated wash unit 12 and that enable collection, storage and transmission of wash data, and operation and maintenance data. A pendant 50 is in communication with the controls 48 and connected thereto by a retractable cable, in one example. The pendant 50 can be brought to the turbine engine by the operator for remote operation of the integrated wash unit 12, which may be arranged at the aircraft site but away from the turbine engine.

The framework 14 includes lights 52, which may be taillights appropriate for configurations in which the integrated wash unit 12 is used with the trucks 10, 110. Spotlights 54 are provide on the framework 14, in one example, and can be positioned to illuminate the work site at night. Tool boxes 56 and other storage areas, such as manifold storage 38 are provided within the enclosure 18 for storage of various tools and spares, for example.

Referring to FIG. 3, a method of using the integrated wash unit 12 is schematically illustrated at 60. As indicated by block 62, water from the facility or recycled water is received by the integrated wash unit 12. Facility water is supplied by reel 44c and/or through the inlet reel 44a from the water collector. The water is treated, at block 64, by the water reclamation tanks 46, water treatment containers 40 and/or deionizing tanks 42. The clean, deionized water is heated and stored in storage tanks 36, as indicated at block 66.

The water from storage tank 36 is pressurized by the pump 26 at block 68, which is driven by the power plant 22 through transmission device 24 or through the generator 30 and an electric motor (not shown). As indicated at block 70, the water from the storage tank 36 is delivered through outlet reel 44b, which is connected to the spraying manifold (normally stored in manifold storage area 38). The unclean water is captured using the water collector and returned to the water reclamation tank 46 through the inlet reel 44a, as indicated at block 72.

Although a preferred embodiment has been disclosed, a worker of ordinary skill in this art would recognize that certain modifications would come within the scope of the claims. For that reason, the following claims should be studied to determine their true scope and content.

What is claimed is:

1. A method of manufacturing a wash unit comprising the steps of:
providing a framework;
securing a wash unit to the framework;
securing a water treatment assembly to the framework; and
securing an enclosure to the framework about the wash unit and water treatment assembly.

2. The method according to claim 1, wherein the enclosure securing step includes providing access panels on the enclosure.

3. The method according to claim 1, wherein the framework providing step includes providing a skid, and the wash unit and water treatment securing steps include supporting the wash unit and water treatment assembly on the skid.

4. The method according to claim 1, comprising the step of securing a power plant on the framework, the power plant coupled to a pump supported on the framework.

5. The method according to claim 4, comprising securing a storage tank to the framework, the storage tank fluidly coupled to the pump.

6. The method according to claim 5, comprising securing a water reclamation tank to the framework, and securing a water treatment container to the framework, the water treatment container fluidly coupled to the storage tank and including at least one of a chemical and a filter for cleaning reclaimed water.

7. The method according to claim 6, comprising securing a deionizing tank to the framework, the deionizing tank fluidly coupled to and upstream from the storage tank.

8. The method according to claim 1, comprising the step of securing a power plant on the framework, the power plant coupled to a generator, the generator powering a motor coupled to a pump supported on the framework.
